(19) United States
(12) Patent Application Publication
(10) Pub. No.: US 2023/0323125 A1
(43) Pub. Date: Oct. 12, 2023

(54) POLYPHOSPHORIC ACID (PPA) RESISTANT SULFIDE SCAVENGERS FOR ASPHALT

(71) Applicant: BL Technologies, Inc., Minnetonka, MN (US)

(72) Inventors: Hitesh Bagaria, Minnetonka, MN (US); Moshood Adewale, Minnetonka, MN (US); Nimeshkumar Patel, Minnetonka, MN (US); Roberto Gutierrez, Minnetonka, MN (US)

(21) Appl. No.: 18/026,815

(22) PCT Filed: Sep. 2, 2021
(86) PCT No.: PCT/US21/48929

§ 371 Date: Mar. 16, 2023

Related U.S. Application Data
(60) Provisional application No. 63/086,669, filed on Oct. 2, 2020.

(51) Int. Cl. C08L 95/00; C07F 1/08; C10C 3/02

(52) U.S. Cl. CPC C08L 95/00; C07F 1/08; C10C 3/026; C08L 2555/80

(57) ABSTRACT

A composition providing a copper-carboxylic acid complex, the copper-carboxylic acid complex having a molar ratio of copper (Cu) to carboxylic acid that is between 1:0.1 and 1:1.5; and an asphalt composition. A method for scavenging hydrogen sulfide from asphalt, the method providing a composition comprising a copper-carboxylic acid complex having a molar ratio of copper (Cu) to carboxylic acid of the copper-carboxylic acid complex is between 1:0.1 and 1:1.5; and adding the composition to an asphalt composition.

### CROSS REFERENCE TO RELATED APPLICATION

This application claims the priority benefit of U.S. Provisional Patent Application Ser. No. 63/086,669 filed Oct. 2, 2020, the entirety of which is incorporated herein by reference.

### FIELD OF INVENTION

The disclosed technology provides for a composition and method for scavenging H2S from asphalt, and more specifically, scavenging H2S from asphalt that has been modified with polyphosphoric acid (PPA).

### BACKGROUND OF THE INVENTION

Petroleum asphalt is produced as a residue of a thermal separation refinery process. For example, asphalt, the bottoms product of a refinery distillation process, undergoes thermal cracking to produce hydrogen sulfide gas, a highly toxic and flammable gas. Driven by the need to protect employees, H2S scavenging chemicals are added to asphalt to minimize personnel H2S exposure.

Generally, H2S present in asphalt is scavenged by the addition of a scavenger composition to the asphalt either prior to or concurrent with heating the asphalt. The most widely used asphalt H2S scavenger is zinc carboxylate salt, in particular zinc octoate. However, while zinc is an excellent H2S scavenger for unmodified asphalt, the H2S returns when asphalt is modified with polyphosphoric acid (PPA).

Thus, what is needed in the art is a composition and method for scavenging H2S from asphalt that has been modified to avoid the aforementioned limitations.

### SUMMARY OF THE INVENTION

The disclosed technology provides for a composition and method for scavenging H2S from asphalt, and more specifically, scavenging H2S from asphalt that has been modified with polyphosphoric acid (PPA).

In one aspect of the disclosed technology, a composition is provided. The composition comprises a unique copper-carboxylic acid complex wherein the molar ratio of copper (Cu) to carboxylic acid is between 1:0.1 and 1:1.5; and an asphalt composition.

In some embodiments, the novel copper-carboxylic acid comprises from 1% to 50% wt. copper. In some embodiments, the copper-carboxylic acid complex comprises from about 10% to about 50% wt. copper. In some embodiments, the copper-carboxylic acid complex comprises about 15% to about 25% wt. copper.

In some embodiments, the copper-carboxylic acid complex comprises from about 10% to 90% Cu-acid complex, and about 90% to 10% organic solvent. In some embodiments, the copper-carboxylic acid complex comprises from about 20% to 40% Cu-acid complex, and from about 60% to 80% organic solvent.

In some embodiments, the viscosity of the copper-carboxylic acid complex is less than about 200 centipoise at 5° C. In some embodiments, the viscosity of the copper-carboxylic acid complex is less than about 100 centipoise at 20° C.

In some embodiments, the molar ratio of copper (Cu) to carboxylic acid is between about 1:0.2 to 1.0:1.0. In some embodiments, the molar ratio of copper (Cu) to carboxylic acid is about 1.0:0.25.

In some embodiments, the copper (Cu) comprises reaction products of Cu metal, Cu oxides, and/or inorganic Cu salts with a carboxylic acid with about 4-22 carbon atoms.

In some embodiments, the copper-carboxylic acid complex is represented by the general formula:

R1-Cu—O—(Cu—O)n-Cu—R2

wherein R1 and R2 are carboxylic acids with about 4-22 carbon atoms; and n is 0 to 20.

In some embodiments, R1 and R2 independently comprises butanoic acid, pentanoic acid, hexanoic acid, heptanoic acid, octanoic acid, nonanoic acid, decanoic acid, undecanoic acid, dodecanoic acid, tridecanoic acid, tetradecanoic acid, pentadecanoic acid, hexadecenoic acid, heptadecanoic acid, octadecanoic acid, nonadecanoic acid, eicosanoic acid, heneicosanoic acid, Behenic acid, naphthenic acids, cyclic carboxylic acids, aromatic carboxylic acids and/or the isomers thereof.

In some embodiments, the asphalt composition is acidic. In some embodiments, the asphalt composition comprises an asphalt modifier.

In some embodiments, the asphalt modifier comprises mineral acids and/or organic acids. In some embodiments, the mineral acids comprise polyphosphoric acid (PPA), sulfuric acid, hydrochloric acid, and/or nitric acid. In some embodiments, the organic acids comprise formic acid, glacial acetic acid, acetic anhydride, fumaric acid, glycolic acid, malic acid, maleic acid, salicylic acid, succinic acid, benzene sulfonic acid, toluene sulfonic acid, phthalic acid, salicylic acid, and/or benzoic acid.

In some embodiments, the asphalt composition comprises from about 0.1%-10% wt. PPA. In some embodiments, the asphalt composition comprises from about 1-10% wt. PPA. In some embodiments, the asphalt composition comprises from about 1-5% wt. PPA.

In some embodiments, the composition further comprises an amine-aldehyde or alcohol-aldehyde complex. In some embodiments, the amine-aldehyde complex comprises hexahydrotriazines, imines, oxazolidines, secondary amine-HCHO adduct, primary amine HCHO reaction products, and/or a mixture thereof. In some embodiments, the alcohol-aldehyde complex is ethylene glycol-HCHO reaction product, alkanolamine-HCHO reaction product, glycerol-HCHO reaction product, butanol-HCHO reaction product, and/or a mixture thereof.

In yet another aspect of the disclosed technology, a method for scavenging hydrogen sulfide from asphalt is provided. The method comprising providing a composition comprising a copper-carboxylic acid complex, wherein the molar ratio of copper (Cu) to carboxylic acid of the copper-carboxylic acid complex is between 1:0.1 and 1:1.5; and adding the composition to an asphalt composition.

In some embodiments, the copper-carboxylic acid comprises at least 1-50% wt. copper. In some embodiments, the copper-carboxylic acid complex comprises from about 10% to about 50% wt. copper. In some embodiments, the copper-carboxylic acid complex comprises about 15% to about 20% wt. copper.

In some embodiments, the copper-carboxylic acid complex comprises from about 10% to 90% Cu-acid complex, and about 10% to 90% organic solvent. In some embodiments, the copper-carboxylic acid complex comprises from about 20% to 40% Cu-acid complex, and about 60% to 80% organic solvent.

In some embodiments, the viscosity of the copper-carboxylic acid complex is less than about 200 centipoise at 5° C. In some embodiments, the viscosity of the copper-carboxylic acid complex is less than about 100 centipoise at 20° C.

In some embodiments, the copper-carboxylic acid comprises at least 1% wt. copper, and a molar ratio of copper (Cu) to carboxylic acid is about 1.0:0.1 to 1:1.

In some embodiments, the copper-carboxylic acid complex is represented by the general formula:

R1-Cu—O—(Cu—O)n-Cu—R2

wherein R1 and R2 are carboxylic acids with about 4-22 carbon atoms; and n is 0 to 20.

In some embodiments, the asphalt composition is acidic. In some embodiments, the asphalt composition comprises an asphalt modifier. In some embodiments, the asphalt modifier comprises polyphosphoric acid (PPA). In some embodiments, the asphalt composition comprises from about 0.1%-10% wt. PPA. In some embodiments, the asphalt composition comprises from about 1-10% wt. PPA. In some embodiments, the asphalt composition comprises from about 1-5% wt. PPA.

In some embodiments, at least about 10 ppm of the copper-carboxylic acid complex is delivered to the asphalt composition. In some embodiments, about 10 ppm to about 10,000 ppm of the copper-carboxylic acid complex is delivered to the asphalt composition. In some embodiments, less than about 2500 ppm of the copper-carboxylic acid complex is delivered to the asphalt composition.

### DETAILED DESCRIPTION OF EXEMPLARY EMBODIMENTS

The disclosed technology provides for a composition and method for scavenging H2S from unmodified asphalt, and more specifically, a composition and method for scavenging H2S from modified asphalt, for example, but not limited to, asphalt that has been modified with polyphosphoric acid (PPA).

As used herein the terms “scavenge” and “scavenging” are used interchangeably and refer to the situation where an additive composition interacts with hydrogen sulfide in asphalt such that gaseous emissions of hydrogen sulfide from the asphalt are mitigated or eliminated.

In a first embodiment of the disclosed technology, a composition is provided. The composition comprises a novel copper rich copper-carboxylic acid complex, and an asphalt composition. The disclosed copper rich copper-carboxylic acid complex, when added to asphalt that has been modified with PPA, does not release H2S. For example, the novel copper rich copper-carboxylic acid complex described in this invention was shown to have an unexpected Cu to acid mole ratio of 1:<1, where H2S was not released when added to asphalt that is modified with PPA.

Typical copper carboxylates salts have a Cu to acid mole ratio of either 2:1 or 1:1 for a copper oxidation state of Cu²⁺ (cupric) or Cu⁺ (cuprous), respectively. The novel copper-carboxylic acid complex as disclosed herein has lower acid content than traditional carboxylates. Table 2 shows that traditional Zinc and Cu carboxylates have an organic acid content ranging from 43% to 60%, whereas the novel Cu rich complex disclosed here has only 12% organic acid. The acid to metal weight ratio, also shown in Table 2, ranges from 3.3 to 5.4 for traditional Zinc and Cu carboxylates, however this ratio is only 0.7 for the novel Cu carboxylic acid complex. Such reduced carboxylic acid or copper rich complex has the following benefits: (i) since copper is the active material that reacts with H2S, reducing the inactive acid content in the complex significantly reduces the cost of treatment, (ii) in comparison to traditional copper carboxylates and CuCO₃ type particle dispersions, the novel copper rich copper-carboxylic acid complex as disclosed herein has significantly reduced viscosity (Table 2), which makes it easy to pump the material even in cold regions, and (iii) like other forms of copper (as those disclosed in U55000835 and CA2936894), the novel copper rich copper-carboxylic acid complex prevents the release of H2S upon addition of PPA.

In some embodiments, the copper-carboxylic acid complex comprises a molar ratio of copper (Cu) to carboxylic acid that is between 1:0.1 and 1:1.5. In other embodiments, the molar ratio of copper (Cu) to carboxylic acid is between about 1:0.2 to 1.0:1.0; and in other embodiments, the molar ratio of copper (Cu) to carboxylic acid is about 1.0:0.25.

In some embodiments, the copper present in the copper rich copper-carboxylic acid complex comprises reaction products of Cu metal, Cu oxides, and/or inorganic Cu salts with a carboxylic acid with about 4-22 carbon atoms.

In some embodiments, the copper-carboxylic acid complex comprises from 1% to 50% wt. copper. In other embodiments, the copper-carboxylic acid complex comprises from about 10% to about 50% wt. copper, and in other embodiments, the copper-carboxylic acid complex comprises about 15% to about 25% wt. copper. In some embodiments, the copper-carboxylic acid complex comprises about 18% wt. copper.

In some embodiments, the copper-carboxylic acid complex comprises an organic solvent. In some embodiments, the organic solvent comprises aromatic solvents, paraffinic solvents, hydrotreated distillates, glycol ethers, alkyl ethers, and/or fatty alcohols. These organic solvents reduce the viscosity of the complex making it easier to pump and easier to blend with the asphalt stream for efficient H2S scavenging.

In some embodiments, the copper-carboxylic acid complex comprises from about 10% to 90% Cu-acid complex, and about 90% to 10% organic solvent. In other embodiments, the copper-carboxylic acid complex comprises from about 20% to 40% Cu-acid complex, and from about 60% to 80% organic solvent.

Further, the novel copper rich copper-carboxylic acid complex as described herein provides a viscosity that is significantly lower than zinc octoate and traditional Cu carboxylate complexes (as shown in Table 2 below). The disclosed novel copper rich copper-carboxylic acid complex demonstrated resistance to H2S reversal by PPA (as shown in Table 1 below), while still providing a product that has extremely low viscosity compared to not only other metal-carboxylate complexes, but also PPA resistant materials, such as, but not limited to, Cu hydroxide and carbonate dispersions, that have very high viscosity. This reduced viscosity offers a significant application advantage by keeping the product pumpable in cold regions.

In some embodiments, the viscosity of the copper-carboxylic acid complex is less than about 200 centipoise at 5° C. In other embodiments, the viscosity of the copper-carboxylic acid complex is less than about 100 centipoise at 20° C.

In some embodiments, the copper-carboxylic acid complex is represented by the general formula:

R1-Cu—O—(Cu—O)n-Cu—R2

wherein R1 and R2 are carboxylic acids with about 4-22 carbon atoms; and n is 0 to 20.

In some embodiments, R1 and R2 independently comprise butanoic acid, pentanoic acid, hexanoic acid, heptanoic acid, octanoic acid, nonanoic acid, decanoic acid, undecanoic acid, dodecanoic acid, tridecanoic acid, tetradecanoic acid, pentadecanoic acid, hexadecenoic acid, heptadecanoic acid, octadecanoic acid, nonadecanoic acid, eicosanoic acid, heneicosanoic acid, Behenic acid, naphthenic acids, cyclic carboxylic acids, aromatic carboxylic acids, and/or the isomers thereof.

The composition further comprises an asphalt composition. It should be understood that the asphalt, also known as bitumen, provided can be obtained from naturally occurring asphalt sources, or synthetically manufactured by refinery operations.

In some embodiments, the asphalt composition comprises certain polymers added to asphalt to improve the high temperature dynamic shear rheometer (DSR) stiffness values without significant loss in the low temperature properties, thereby increasing the useful temperature interval (UTI) of asphalt. In such embodiments, the asphalt is called polymer modified asphalt, or PMA. In some embodiments, acid is often added along with the polymer to bind the polymer to asphalt molecules. In some embodiments, acids are added without polymer to improve the high temperature properties.

In some embodiments, the asphalt composition comprises a polymeric asphalt modifier. In some embodiments, the acid comprises mineral acids and/or organic acids. In some embodiments, the mineral acids comprise polyphosphoric acid (PPA), sulfuric acid, hydrochloric acid, and/or nitric acid. In some embodiments, the organic acids comprise formic acid, glacial acetic acid, acetic anhydride, fumaric acid, glycolic acid, malic acid, maleic acid, salicylic acid, succinic acid, benzene sulfonic acid, toluene sulfonic acid, phthalic acid, salicylic acid, and/or benzoic acid.

In some embodiments, the asphalt is modified with PPA. It was discovered that the disclosed novel copper rich copper-carboxylic acid complex, when added to asphalt that has been modified with PPA, does not reverse back to H2S.

In some embodiments, the asphalt composition comprises from about 0.1%-10% wt. PPA. In some embodiments, the asphalt composition comprises from about 1-10% wt. PPA. In some embodiments, the asphalt composition comprises from about 1-5% wt. PPA. In some embodiments, the asphalt composition comprises at least about 0.1% wt. PPA; in some embodiments, the asphalt composition comprises at least about 1% wt. PPA; and in other embodiments, the asphalt composition comprises at least about 2% wt. PPA.

The disclosed novel copper rich copper-carboxylate complex was also shown to work synergistically when combined with a secondary amine-aldehyde adducts to prevent H2S reversal by PPA. In some embodiments, the disclosed copper-carboxylic acid complex further comprises an amine-aldehyde or alcohol-aldehyde complex.

In some embodiments, the amine-aldehyde complex comprises hexahydrotriazines, imines, oxazolidines, secondary amine-HCHO adduct, primary amine HCHO reaction products, and/or a mixture thereof. In some embodiments, the alcohol-aldehyde complex is ethylene glycol-HCHO reaction product, alkanolamine-HCHO reaction product, glycerol-HCHO reaction product, butanol-HCHO reaction product, and/or a mixture thereof.

In yet another embodiment of the disclosed technology, a method for scavenging hydrogen sulfide from asphalt is provided. The method comprises providing a composition comprising a copper-carboxylic acid complex, and adding the composition to an asphalt composition.

In some embodiments, the copper-carboxylic acid complex of the present method comprises a molar ratio of copper (Cu) to carboxylic acid of the copper-carboxylic acid complex that is between 1:0.1 and 1:1.5.

In some embodiments, the copper-carboxylic acid complex of the present method comprises at least 1-50% wt. copper. In some embodiments, the copper-carboxylic acid complex comprises from about 10% to about 50% wt. copper, and in other embodiments, the copper-carboxylic acid complex comprises about 15% to about 20% wt. copper, and in other embodiments, the copper-carboxylic acid complex comprises about 18% wt. copper.

In a specific embodiment, the copper-carboxylic acid of the present method comprises at least 18% wt. copper, and a molar ratio of copper (Cu) to carboxylic acid is about 1.0:0.1 to 1:1.

In some embodiments, the copper-carboxylic acid complex of the present method comprises from about 10% to 90% Cu-acid complex, and about 10% to 90% organic solvent. In other embodiments, the copper-carboxylic acid complex comprises from about 20% to 40% Cu-acid complex, and about 60% to 80% organic solvent.

In some embodiments, the viscosity of the copper-carboxylic acid complex in the present method is less than about 200 centipoise at 5° C. In other embodiments, the viscosity of the copper-carboxylic acid complex is less than about 100 centipoise at 20° C.

In some embodiments, the copper rich copper-carboxylic acid complex is represented by the general formula:

R1-Cu—O—(Cu—O)n-Cu—R2

wherein R1 and R2 are carboxylic acids with about 4-22 carbon atoms; and n is 0 to 20.

The method further comprises adding the copper rich copper-carboxylic acid complex to an asphalt composition. The addition of the copper-carboxylic acid complex to the asphalt composition can occur before asphalt is modified by polymer and/or acid, or after asphalt modifiers are added.

In some embodiments, the asphalt composition includes proton donor acids.

In some embodiments, the asphalt composition comprises an asphalt modifier. In some embodiments, the asphalt modifier comprises polyphosphoric acid (PPA). In some embodiments, the asphalt composition comprises from about 0.1%-10% wt. PPA. In some embodiments, the asphalt composition comprises from about 1-10% wt. PPA, and in other embodiments, the asphalt composition comprises from about 1-5% wt. PPA.

In some embodiments, at least about 10 ppm of the copper-carboxylic acid complex is delivered to the asphalt composition. For example, in batch asphalt processes, the disclosed copper-carboxylic acid complex may be added to the mixer before loading asphalt or after loading the asphalt followed by through mixing to distribute the copper. In a continuous flowing stream of asphalt, the disclosed copper-carboxylic acid complex may be injected into the pipeline through a pump choosing a location where the asphalt is sufficiently hot and thin to enable efficient mixing due to the fluid flow.

In some embodiments, about 10 ppm to about 10,000 ppm of the copper-carboxylic acid complex is delivered to the asphalt composition. In other embodiments, less than about 2500 ppm of the copper-carboxylic acid complex is delivered to the asphalt composition.

### Examples

The present technology will be further described in the following examples, which should be viewed as being illustrative and should not be construed to narrow the scope of the disclosed technology or limit the scope to any particular embodiments.

With reference to Table 1, H2S scavenging tests were conducted on asphalt from two different sources (A and B) with or without polyphosphoric acid/PPA-115 at 2% and 4% wt. Asphalt A tests were conducted at 350° F., whereas Asphalt B was tested at 330° F., which represent the actual asphalt field application temperature for the sources. Untreated Asphalt A had a vapor phase H2S concentration of 7500 ppm.

TABLE 1

| | | Dose | % wt. | ppm H2S |
|---|---|---|---|---|
| | | (ppm | PPA | vapor @ 330 |
| Asphalt | Scavenger | vol.) | (115%) | to 350° F. |
| Asphalt A | None | 0 | 0 | 7500 |
| without PPA | Zinc Octoate | 100 | 0 | >2400 |
| | Zinc Octoate | 200 | 0 | 250 |
| | Zinc Octoate | 300 | 0 | 12 |
| | Zinc Octoate | 400 | 0 | 5 |
| | Zinc Octoate | 500 | 0 | 0 |
| | Novel Cu Complex | 100 | 0 | 2800 |
| | Novel Cu Complex | 200 | 0 | 1280 |
| | Novel Cu Complex | 300 | 0 | 0 |
| | Traditional Cu | 500 | 0 | 1300 |
| | complex | | | |
| | Traditional Cu | 1000 | 0 | 2 |
| | complex | | | |
| Asphalt A | None | 0 | 2 | 10,000 |
| with PPA | Zinc Octoate | 500 | 2 | 7500 |
| | Zinc Octoate | 2000 | 2 | 10,000 |
| | Novel Cu complex | 500 | 2 | 2000 |
| | Novel Cu complex | 1000 | 2 | 450 |
| | Novel Cu complex | 1500 | 2 | 0 |
| | Novel Cu complex | 2500 | 4 | 0 |
| Asphalt B | None | 0 | 2 | 1500 |
| with PPA | Zinc octoate | 500 | 2 | 2400 |
| | Zinc octoate | 1000 | 2 | 2800 |
| | Novel Cu complex | 500 | 2 | 1250 |
| | Novel Cu Complex | 1000 | 2 | 0 |
| | Novel Cu complex | 2500 | 4 | 0 |

To achieve a specification of <10 ppm H2S vapor, a dose response study was conducted with the following three scavenger chemistries: (1) Zinc Octoate (current industry workhorse): containing 18% wt. zinc and a ˜70-80% non-volatile matter; (2) the disclosed novel Cu complex: containing at least 18% wt. Cu and ˜25-40% non-volatile matter, prepared with a mixture of acids (C8 through C16) and Cu oxide, where the molar ratio of Cu to carboxylate is 1:˜0.25, which is a uniquely low acid content for a metal-carboxylate complex; and (3) traditional Cu carboxylate complex: specifically Cu (II) neodecanoate containing 10% Cu and 60-70% non-volatile matter.

As shown in Table 1, Asphalt A without PPA showed superior performance of Novel Cu complex in comparison to industry standard zinc octoate and traditional copper carboxylates. When PPA was added, both Asphalt A and B showed zinc octoate was unable to scavenge H2S, whereas novel Cu complex proved to be resistant to PPA even up to 4% wt. PPA-115. For example, a 400 ppm dose of zinc octoate achieved 5 ppm H2S (below specification), whereas the disclosed novel Cu complex completely scavenged H2S to 0 ppm at only 300 ppm dose, thus demonstrating the superior performance over zinc octoate chemistry. In contrast, the traditional Cu complex could achieve the <10 ppm H2S specification only at 1000 ppm dose.

When 2% wt. PPA (i.e. the typical amount to modify asphalt) was added, zinc octoate was unable to scavenge the H2S. For Asphalt A with PPA, even 2000 ppm zinc octoate could not reduce the H2S levels from the initial 10,000 ppm, whereas 1500 ppm of the disclosed novel Cu complex reduced the H2S from 10,000 ppm to 0 ppm H2S, thus demonstrating superior resistance to H2S reversal by PPA. When PPA level was increased to 4% wt. 2500 ppm of the disclosed novel Cu complex kept H2S at 0 ppm. A similar trend is observed with Asphalt B plus 2% and 4% wt. PPA.

With reference to Table 2, viscosity measurements show that the novel cu complex showed an unexpectedly low viscosity at a high metal content of 18% Cu compared to traditional zinc octoate and other copper(II) carboxylates. Viscosity measurements of various complexes are shown in Table 2 at two temperatures, 5° C. and 20° C.

TABLE 2

| | | % wt. | wt. ratio | | |
|---|---|---|---|---|---|
| | % wt. | organic | of acid | Viscosity @ | Viscosity @ |
| Chemistry | metal | acid | to metal | 5° C. (cP) | 20° C. (cP) |
| Zinc Octoate | 18 | 60% | 3.3 | 230 | 80 |
| Novel Cu(II) | 18 | 12% | 0.7 | 73 | 48 |
| Carboxylic acid | | | | | |
| Complex | | | | | |
| Traditional Cu(II) | 10 | 54 | 5.4 | 4100 | 1100 |
| neodecanoate | | | | | |
| Traditional Cu(II) | 8 | 43 | 5.4 | 1650 | 560 |
| naphthenate | | | | | |
| Traditional | 12 | 55 | 4.6 | 1690 | 650 |
| Cu(II)Octoate | | | | | |

It was shown that the disclosed novel Cu complex exhibited the lowest viscosity even at a high metal content of 18% Cu, as compared to the traditional Cu octoate, Cu naphthenate and Cu neodecanoate, which were much more viscous and at a lower % Cu.

As shown in Table 2, the traditional Cu complexes (Cu neodecanoate, naphthenate and octoate) showed the highest viscosities at several 1000 cP @ 5° C. at a Cu content this lower than the disclosed novel Cu carboxylate complex. Even zinc octoate, exhibited a viscosity of 230 cP @ 5° C. The disclosed novel Cu carboxylate was the only chemistry that exhibited <100 cP @ 5° C. due to the uniquely low acid content with Cu:acid molar ratio of 1:<1. This decreased viscosity is expected to keep the product pumpable in cold conditions.

With reference to Table 3, asphalt from source ‘B’ was modified with 1% wt. PPA for H2S scavenging tests with secondary amine formaldehyde adducts (SAFA), novel copper complex and a combination of SAFA and novel copper complex.

TABLE 3

| | | Chemistry | Chemistry | |
|---|---|---|---|---|
| | | #1 Dose | #2 Dose | ppm H2S vapor |
| Chemistry #1 | Chemistry #2 | (ppmv) | (ppmv) | @ 330° F. |
| None | None | 0 | 0 | 550 |
| Novel Cu | None | 1000 | 0 | 110 |
| Complex | | | | |
| SAFA #1 | None | 1000 | 0 | 400 |
| SAFA #1 | Novel Cu | 500 | 500 | 10 |
| | Complex | | | |
| SAFA #2 | None | 1000 | 0 | 370 |
| SAFA #2 | Novel Cu | 500 | 500 | 0 |
| | complex | | | |

[SAFA#1 = dibutylamine-HCHO adduct; SAFA#2 = dipropylamine-HCHO adduct]

As shown in Table 3, the combination of SAFA with the novel copper complex was found to show synergistic scavenging when combined with SAFA. For example, the disclosed novel Cu carboxylate complex was shown to perform synergistically when combined with secondary amine HCHO adduct.

TABLE 4

| | | Dose | % wt. | PG |
|---|---|---|---|---|
| | | (ppm | PPA | AASHTO |
| Asphalt | Scavenger | vol.) | (115%) | T315 |
| Asphalt A | None | 0 | 0 | 58 |
| | Novel Cu Complex | 2000 | 0 | 58 |
| | Novel Cu Complex | 2000 | 1 | 64 |
| Asphalt B | None | 0 | 0 | 58 |
| | Novel Cu Complex | 2000 | 1 | 82 |

With reference to Table 4, PPA is used to improve the performance grade (PG) of asphalt by increasing the upper temperature limit. Such improvement is determined by DSR as outlined in AASHTO T315. As shown in Table 4, two asphalt samples dosed with novel Cu complex maintained the ability to improve the PG of the asphalt by addition of PPA.

While embodiments of the disclosed technology have been described, it should be understood that the present disclosure is not so limited and modifications may be made without departing from the disclosed technology. The scope of the disclosed technology is defined by the appended claims, and all devices, processes, and methods that come within the meaning of the claims, either literally or by equivalence, are intended to be embraced therein.

1. A composition, the composition comprising:
a copper-carboxylic acid complex wherein the molar ratio of copper (Cu) to carboxylic acid is between 1:0.1 and 1:1.5; and
an asphalt composition.

2. The composition as recited in claim 1, wherein the copper-carboxylic acid comprises (i) from 1% to 50% wt. copper, (ii) from about 10% to about 50% wt. copper, or (iii) about 15% to about 25% wt. copper.

3-4. (canceled)

5. The composition as recited in claim 1, wherein the copper-carboxylic acid complex comprises (i) from about 10% to 90% Cu-acid complex, and about 90% to 10% organic solvent, or (ii) from about 20% to 40% Cu-acid complex, and from about 60% to 80% organic solvent.

6. (canceled)

7. The composition as recited in claim 5, wherein the viscosity of the copper-carboxylic acid complex is (i) less than about 200 centipoise at 5° C., or (ii) less than about 100 centipoise at 20° C.

8. (canceled)

9. The composition as recited in claim 1, wherein the molar ratio of copper (Cu) to carboxylic acid is (i) between about 1:0.2 to 1.0:1.0, or (ii) about 1.0:0.25.

10. (canceled)

11. The composition as recited in claim 2, wherein the copper (Cu) comprises reaction products of Cu metal, Cu oxides, and/or inorganic Cu salts with a carboxylic acid with about 4-22 carbon atoms.

12. The composition as recited in claim 1, wherein the copper-carboxylic acid complex is represented by the general formula
R1-Cu—O—(Cu—O)n-Cu—R2
wherein R1 and R2 are carboxylic acids with about 4-22 carbon atoms; and n is 0 to 20.

13. The composition as recited in claim 12, wherein R1 and R2 independently comprises butanoic acid, pentanoic acid, hexanoic acid, heptanoic acid, octanoic acid, nonanoic acid, decanoic acid, undecanoic acid, dodecanoic acid, tridecanoic acid, tetradecanoic acid, pentadecanoic acid, hexadecenoic acid, heptadecanoic acid, octadecanoic acid, nonadecanoic acid, eicosanoic acid, heneicosanoic acid, Behenic acid, naphthenic acids, cyclic carboxylic acids, aromatic carboxylic acids and/or the isomers thereof.

14. The composition as recited in claim 1, wherein the asphalt composition is acidic.

15. The composition as recited in claim 14, wherein the asphalt composition comprises an asphalt modifier, and wherein the asphalt modifier comprises mineral acids and/or organic acids.

16. (canceled)

17. The composition as recited in claim 15, wherein the mineral acids comprise polyphosphoric acid (PPA), sulfuric acid, hydrochloric acid, and/or nitric acid, and wherein the organic acids comprise formic acid, glacial acetic acid, acetic anhydride, fumaric acid, glycolic acid, malic acid, maleic acid, salicylic acid, succinic acid, benzene sulfonic acid, toluene sulfonic acid, phthalic acid, salicylic acid, and/or benzoic acid.

18. (canceled)

19. The composition as recited in claim 1, wherein the asphalt composition comprises (i) from about 0.1-10% wt. PPA, or (ii) from about 1-5% wt. PPA.

20. (canceled)

21. The composition as recited in claim 1, further comprising an amine-aldehyde or alcohol-aldehyde complex, and wherein the amine-aldehyde complex comprises hexahydrotriazines, imines, oxazolidines, secondary amine-HCHO adduct, primary amine HCHO reaction products, and/or a mixture thereof.

22. (canceled)

23. The composition as recited in claim 1, further comprising an amine-aldehyde or alcohol-aldehyde complex, and wherein the alcohol-aldehyde complex is ethylene glycol-HCHO reaction product, alkanolamine-HCHO reaction product, glycerol-HCHO reaction product, butanol-HCHO reaction product, and/or a mixture thereof.

24. A method for scavenging hydrogen sulfide from asphalt, the method comprising:
providing a composition comprising a copper-carboxylic acid complex, wherein the molar ratio of copper (Cu) to carboxylic acid of the copper-carboxylic acid complex is between 1:0.1 and 1:1.5; and
adding the composition to an asphalt composition,
wherein the copper-carboxylic acid complex is represented by the general formula:
R1-Cu—O—(Cu—O)n-Cu—R2
wherein R1 and R2 are carboxylic acids with about 4-22 carbon atoms; and n is 0 to 20.

25. The method as recited in claim 24, wherein the copper-carboxylic acid comprises (i) at least 1-50% wt. copper, (ii) from about 10% to about 50% wt. copper, (iii) from about 10% to about 50% wt. copper, or (iv) about 15% to about 20% wt. copper.

26-27. (canceled)

28. The method as recited in claim 24, wherein the copper-carboxylic acid complex comprises (i) from about 10% to 90% Cu-acid complex, and about 10% to 90% organic solvent, or (ii) from about 20% to 40% Cu-acid complex, and about 60% to 80% organic solvent.

29. (canceled)

30. The method as recited in claim 24, wherein the viscosity of the copper-carboxylic acid complex is (i) less than about 200 centipoise at 5° C., or (ii) less than about 100 centipoise at 20° C.

31. (canceled)

32. The method as recited in claim 24, wherein the copper-carboxylic acid comprises at least 18% wt. copper, and a molar ratio of copper (Cu) to carboxylic acid is about 1.0:0.1 to 1:1.

33. (canceled)

34. The method as recited in claim 24, wherein the asphalt composition is acidic.

35. The method as recited in claim 34, wherein the asphalt composition comprises an asphalt modifier.

36. The method as recited in claim 35, wherein the asphalt modifier comprises polyphosphoric acid (PPA), and wherein the asphalt composition comprises (i) from about 0.1-10% wt. PPA, or (ii) from about 1-5% wt. PPA.

37-38. (canceled)

39. The method as recited in claim 24, wherein (i) at least about 10 ppm of the copper-carboxylic acid complex is delivered to the asphalt composition, (ii) about 10 ppm to about 10,000 ppm of the copper-carboxylic acid complex is delivered to the asphalt composition, or (iii) less than about 2500 ppm of the copper-carboxylic acid complex is delivered to the asphalt composition.

40-41. (canceled)
